(19) United States
(12) Patent Application Publication
(10) Pub. No.: US 2014/0316877 A1
(43) Pub. Date: Oct. 23, 2014

(54) METHODS OF PROMOTING PRINT DEVICE USAGE DURING NON-PEAK TIMES

(71) Applicant: XEROX CORPORATION, Norwalk, CT (US)

(72) Inventors: Trevor Snyder, Newberg, OR (US); Paul Gregory Van Gasse, Mountain View, CA (US); Jignesh P. Sheth, Naugatuck, CT (US)

(73) Assignee: Xerox Corporation, Norwalk, CT (US)

(21) Appl. No.: 13/868,530

(22) Filed: Apr. 23, 2013

(51) Int. Cl. G06Q 30/02; G06Q 50/10

(52) U.S. Cl. CPC G06Q 30/0235; G06Q 50/10; G06Q 30/0237
USPC 705/14.35

(57) ABSTRACT

A method and system for promoting usage of a print device during non-peak time periods is disclosed. A print device promotion system includes at least one print device, a processor in communication with the at least one print device and a computer readable storage medium. The storage medium is configured to store program instructions which, when executed, cause the processor to receive data corresponding to measurements of usage of a print device over a plurality of baseline time periods; identify at least one non-peak time period; select a promotion for the print device; receive data corresponding to measurements of usage of the print device over a plurality of additional time periods; determine whether the usage during the time window satisfied the one or more target usage criteria; and offer the consumer the consumable item at the reduced price.

### BACKGROUND

Users of print services and devices consistently find it desirable to reduce the cost of printing. For an office print device, cost is a significant issue for customers and is known to cause lower printer page volume. For example, high printing costs may encourage companies to establish policies discouraging personal printing. There also may be pressure to reduce work related output. These costs, as well as environmental, social, and technological influences, are causing print volumes to shrink. However, printed material can add true value even over newer technologies. This includes printing for advertisements, information distribution, and simplifying work related tasks. For example, hard copies of review and presentation materials are portable and allow for easy note taking.

To promote print device usage it is desirable to reduce barriers to printing and help customers control costs.

### SUMMARY

In an embodiment, a method and system for promoting usage of a print device during non-peak time periods is disclosed. A print device promotion system includes at least one print device, a processor in communication with the at least one print device and a computer readable storage medium. The storage medium is configured to store program instructions which, when executed, cause the processor to receive data corresponding to measurements of usage of a print device over a plurality of baseline time periods; identify at least one non-peak time period, each non-peak time period being one of the baseline time periods during which the measurement of usage is below a lower threshold level; select a promotion for the print device, wherein the promotion represents a reduced price for a consumable item that is used by the print device, the promotion comprising a time window and one or more target usage criteria; generate a message with the selected promotion; receive data corresponding to measurements of usage of the print device over a plurality of additional time periods, wherein at least one of the additional time periods corresponds to the time window of the promotion; determine whether the usage during the time window satisfied the one or more target usage criteria; and offer the consumer the consumable item at the reduced price.

Optionally, the system may receive an acceptance to the offering via consumer input of a response to the promotion at the print device. Alternatively, the promotional system may output the message with the selected promotion at the print device.

Optionally, embodiments of the disclosed promotional system may identify at least one peak time period that has at least one of the baseline time periods during which the measurement of usage is above an upper threshold level. At least one of the additional time periods for which data was received is determined to correspond to at least one of the peak time periods. The promotional system also determines whether the usage during any additional time period that corresponds to a peak time period dropped below the upper threshold level. In embodiments, the promotion system performs the offering only if the usage during each additional time period that corresponds to a peak time period did not drop below the upper threshold level. In some embodiments the promotional system identifies a first variable, a second variable, and a third variable. Each variable corresponds to a usage measurement during a plurality of time intervals, and the time intervals for each variable are unique to the variable. Upon identifying a condition that the measurement of usage during the measurement period for one of the variables is below the lower threshold level, the promotional system reduces the lower threshold. Alternatively, upon identifying a condition that the measurements of usage during the measurement period for one of the variables is above the upper threshold level, the promotional system increases the lower threshold level.

In some embodiments, the promotional system compiles the data corresponding to measurements of usage during the plurality of baseline time periods into a usage history and forecasts at least one future time period where usage is expected to be below the lower threshold level based on the usage history. The time window is set by the promotional system to correspond to the at least one future time period.

Optionally, before selecting the promotion, a baseline revenue is generated for the print device based on the data corresponding to measurements of usage during the plurality of baseline time periods. In these optional embodiments, the promotional system performs the offering only if the baseline revenue is below a lower threshold revenue level. Alternatively, after performing the offering, the promotional system generates a promotional revenue for the print device based on the measurements of usage during the time window. If the promotional revenue is greater than the baseline revenue, the number of non-peak time periods is increased by adjusting the lower threshold level or the upper threshold level. The system may also discontinue the adjusting if the number of identified non-peak time periods reaches a predetermined maximum.

In some embodiments, the system establishes a plurality of categories of usage, with each category corresponding to a type of print job. A subset of the plurality of categories are established as qualifying print jobs and only qualifying print jobs are counted in the measurements of usage during the plurality of additional time periods.

In an embodiment, a method includes a promotion system receiving data corresponding to measurements of usage of a print device over a plurality of baseline time periods and identifying at least one non-peak time period, each non-peak time period being one of the baseline time periods during which the measurement of usage is below a lower threshold level. The method continues with the system selecting a promotion for the print device, wherein the promotion represents a reduced price for a consumable item that is used by the print device, the promotion comprising a time window and one or more target usage criteria. The system generates a message with the selected promotion. The system receives data corresponding to measurements of usage of the print device over a plurality of additional time periods, wherein at least one of the additional time periods corresponds to the time window of the promotion. The system determines whether the usage during the time window satisfied the one or more target usage criteria and offers the consumer the consumable item at the reduced price.

In an embodiment, another method of promoting usage of a print device during non-peak time period includes a promotion system receiving data corresponding to measurements of usage of a print device over a plurality of baseline time periods and identifying at least one non-peak time period, each non-peak time period being one of the time periods during which the measurement of usage is below a lower threshold level. The system selects selecting a promotion for the print device, wherein the promotion represents a reduced price for a function of the print device, the promotion comprising a time window and one or more target usage criteria. A message is generated by the system with the selected promotion. The system receives data corresponding to measurements of usage of the print device over a plurality of additional time periods, wherein at least one of the additional time periods corresponds to the time window of the promotion, and at least one of the additional time periods corresponds to a non-promotional time period. A payment amount due is determined by the system for usage during the plurality of additional time periods by the system applying a standard price to the usage that occurred during each non-promotional time period, and applying the promotional price to the usage that occurred during the time window of the promotion. The system generates a statement of the payment amount due.

### BRIEF DESCRIPTION OF THE DRAWINGS

FIG. 1 is a diagram of a print device network.

FIG. 2 is a diagram showing an example of printing peak and non-peak time periods.

FIG. 3 is a flow chart describing a method of providing a promotion based on usage.

FIG. 4 is a flow chart describing a method of providing a promotion based on revenue.

FIG. 5 is a flow chart describing a method of identifying peak and non-peak time periods.

FIG. 6 is a flow chart describing a method of providing a promotion based on print job categories.

FIG. 7 is a block diagram depicting internal computer hardware that may be used to contain or implement program instructions according to an embodiment.

### DETAILED DESCRIPTION

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this document is to be construed as an admission that the embodiments described in this document are not entitled to antedate such disclosure by virtue of prior invention. As used in this document, the term “comprising” means “including, but not limited to.”

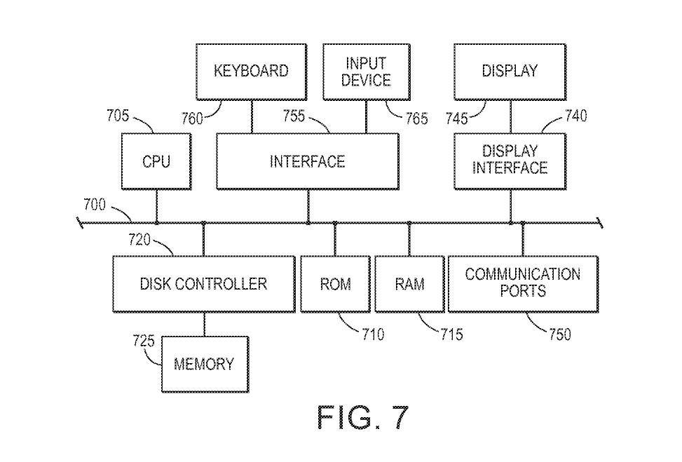

A “computing device” or a “processor” refers to a computer or other machine that performs one or more operations according to one or more programming instructions. An example of a computing device or processor is described in reference to FIG. 7.

A “print device” refers to a device capable of performing one or more print-related functions. For example, a print device may include a printer, a scanner, a copy machine, a multifunction device, a collator, a binder, a cutter or other similar equipment. A “multifunction device” is a device that is capable of performing two or more distinct print-related functions. For example, a multifunction device may have print and scan capabilities.

A “print job” refers to a job that can be processed by a print device. For example, a print job may include one or more operations that are performed on a document that is printed, scanned or otherwise processed by a print device.

A “peak time period” is a time period where usage of one or more print devices (i.e. the print job volume) is at or above an upper threshold. A “non-peak time period” is a time period where usage of the print device or devices is at or below a lower threshold. Each threshold may be an absolute value. Alternatively, it may be determined as a fraction or percentage of a measured value. For example, a non-peak period may be any period where print job value is less than 20% of the maximum valuing during any time period, or less than 50% of the average volume over a group of time periods. The scenarios described in this document are not limited in this regard.

This document describes an apparatus and method of offering promotions and printing incentives that result in printing related revenue advantages. Algorithms are used to track usage by time period, identify low and/or no use (i.e., non-peak) time periods and enable incentives by offering effectively low and/or no cost printing during appropriate timeframes within those non-peak periods.

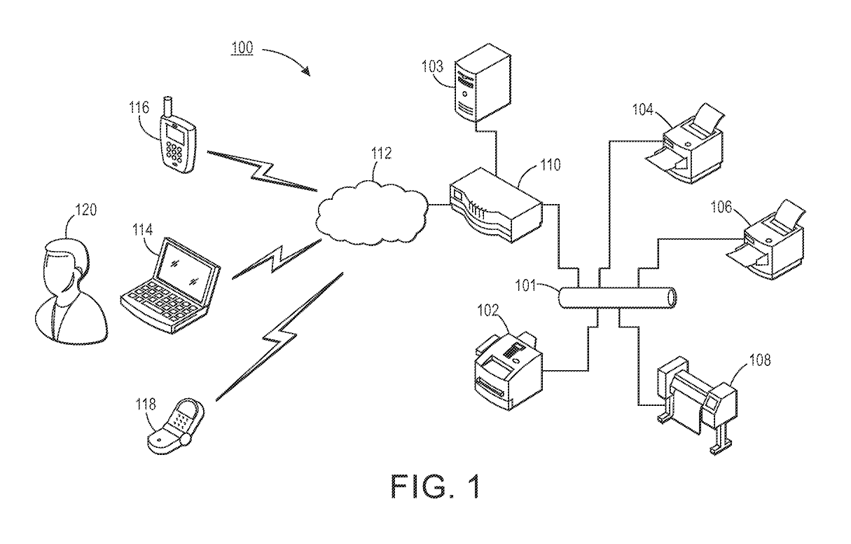

Referring to FIG. 1, a system diagram is provided that describes a system 100 in which the methods described in this document can be implemented. System 100 includes a network 101. Although shown in FIG. 1 as a wired network, network 101 may also be a wireless network. Connected to network 101 are a number of print devices 102, 104, 106, 108. As used in this document, the term “connected” refers to any configuration in which two or more devices may share data or programming instructions or other electronic communications with each other. Each print device may be any device capable of performing one or more print-related functions. For example, print device 102 may be a multi-function machine, i.e., a printer/scanner/fax combination. In another scenario, print devices 104, 106 are networkable laser printers. In another scenario, print device 108 is a large format plotter. These examples are provided for illustration only and the scenarios described herein are not limited in this regard.

Also connected to network 101 is a networking device 110. Networking device 110 may be any device capable of forwarding, routing, or otherwise transmitting packets and/or messages through network 101. Network device may also include or be connected to a print server that allows other terminals connected to network 101 (not shown in FIG. 1) to send print jobs to the print devices 102, 104, 106, 108. Connected to networking device 110 is server 103. Server 103 may include various management and analytic software packages that enable a user or administrator of the network 101 to monitor and manage the print network. For example, server 103 may include a promotion offering system operative to provide promotions designed to encourage usage of print devices 102, 104, 106, 108 during off-peak time periods.

Network device 110 is also capable of connecting to a communications network 112 such as the Internet. Through the Internet 112, a user 120 may connect to the network device 110 to send print jobs to the print devices from personal computer 114, smart phone 116, and/or mobile device 118. With suitable software, any device capable of connecting to the internet is suitable for sending print jobs to the print devices 102, 104, 106, 108. Note that in FIG. 1, network 112 and network 101 are shown as separate networks. Alternatively, network 112 and network 101 may be parts of the same network.

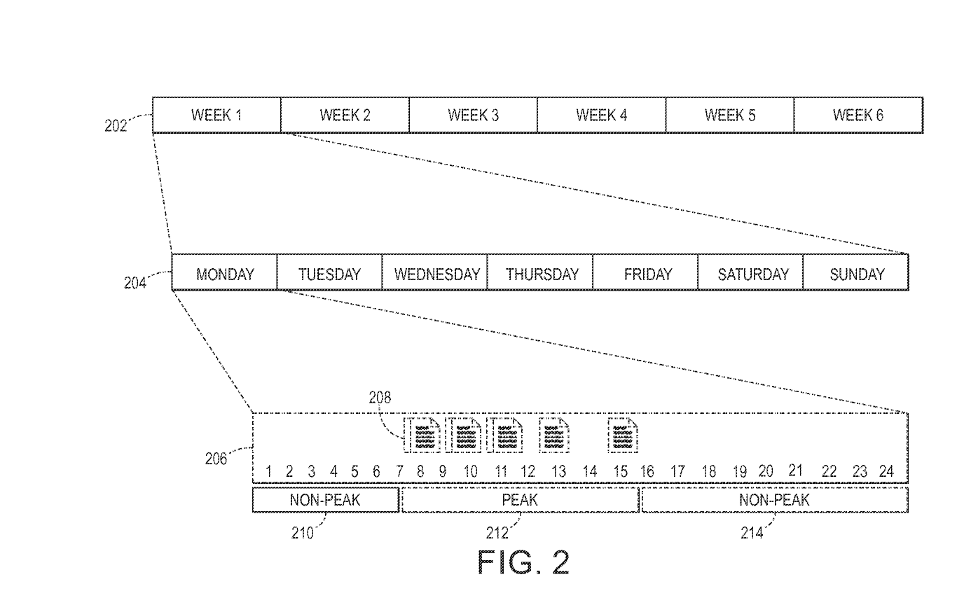

Referring now to FIG. 2, a chart is provided that describes example time periods of usage that may be analyzed for the provision of promotions. In this example, time period 202 is divided into weeks 1 through 6. A subdivision of each sampling period, such as each week, can be represented as a separate time period, e.g. time period 204. Each subdivision may be further divided, for example, into days that can be represented as separate time periods, e.g. time period 206. Time period 206 (which, in the scenario shown in FIG. 2, is represented as Monday of Week 1) includes twenty-four (24) hours. Throughout a normal day, e.g. time period 206, any number of print jobs 208 may be sent to one or more print devices. In the scenario shown in FIG. 2, the print usage, as represented by the volume of print jobs 208, is substantially confined between hours 7 and 16. As a result, the day can further be split into two non-peak periods, i.e. time periods 210, 214, and a peak period, i.e. time period 212. One of skill in the art will recognize that each peak and non-peak period may be broken up into smaller periods, e.g. so that the total time period 210, 212, and/or 214 can be represented as a set of time periods of uniform length. The scenarios described herein are not limited in this regard.

In addition, the respective time periods described in FIG. 2 can also represent analytical time periods for analyzing the usage pattern(s) of one or more print devices. For example, the diagram of FIG. 2 may represent the usage of a print device, e.g. 102 of FIG. 1. A usage measurement software program may be used on a networked computer connected to the print device, e.g. server 103 of FIG. 1 or may be operated with the device 102 itself. The software program measures the usage of the print device over a number of predetermined time periods to determine the peak and non-peak time periods. In one scenario, shown in FIG. 2, a print device is heavily used in the morning, between hours 7 and 12 and moderately used between the hours of 12 and 16. The print device is rarely used between hours 1 through 7 and hours 16 through 24.

The usage pattern may be developed by analyzing usage during multiple time periods and averaging across different period lengths. For example, a scenario may include measuring usage each hour, each day, and each week or month. Certain hours, days, or weeks may have a higher or lower usage depending on a number of factors. For example, usage may be higher on Mondays and lower on Fridays due to employee patterns. A week that includes a holiday, such as Memorial Day, may have lower usage compared to a full work week. In another example, a month may have substantially more or less usage depending on the number of work days in the calendar month (e.g., February may have a lower usage than October).

In another scenario, the time periods described in FIG. 2 may also be used to determine when to offer a promotion to encourage use during non-peak times. For example, a promotion system may offer a promotion for time periods that follow two consecutive non-peak time periods. In one scenario, the time period between hours 16 and 18 may be two consecutive non-peak time periods, i.e. 16-17 and 17-18. As a result, the time period between hours 18 and 19 may be a promotional time period where promotions are offered to encourage printing. Alternatively, the entire period between hour 16 and hour 19 may be selected as a promotional time period. Optionally, the promotion may be offered in the identified hours during the days that correspond to the baseline measurements. For example, if the baseline data show that hours 16-19 are a non-peak period on Fridays but a peak period on Mondays, the system may offer the promotion during hours 16-19 on Fridays but not during such hours on Mondays. The scenarios disclosed in this document are not limited in this regard.

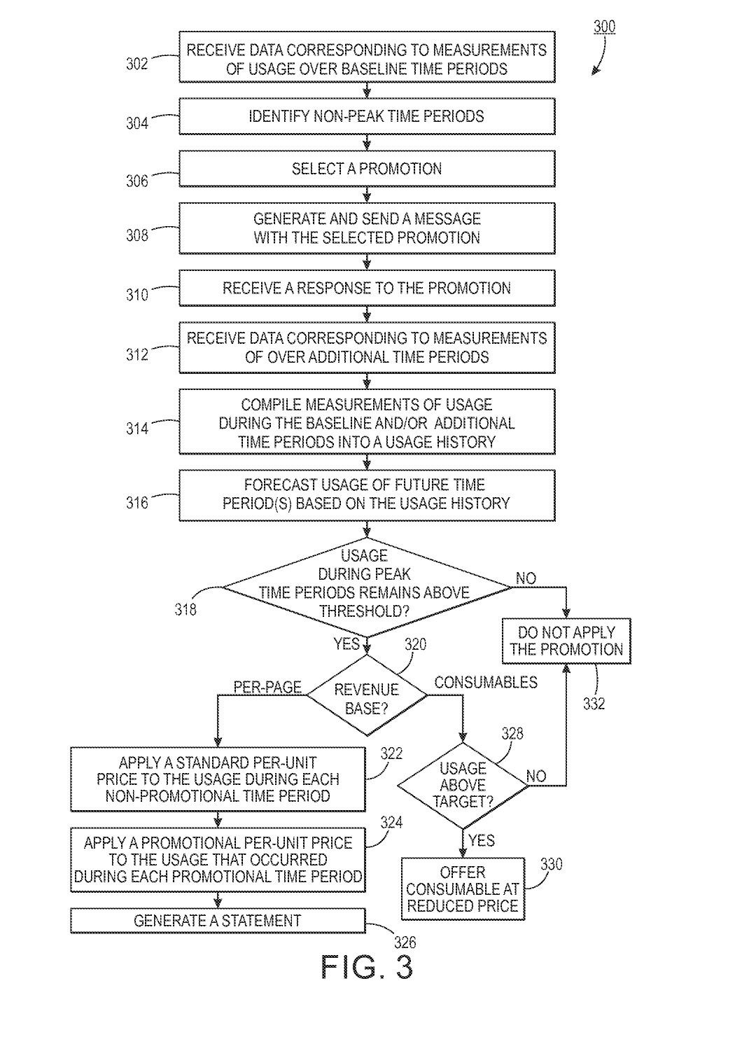

FIGS. 3-6 provide flow charts describing various methods of providing promotions to encourage print device use during non-peak time periods. As will become clear, various portions of the methods may be interchangeable. For example, one step in one method shown in one figure may be applicable to another method shown in another figure. Therefore, the methods described herein are not intended to be mutually exclusive.

Referring now to FIG. 3, a flow chart is provided describing a method 300 of providing a promotion to encourage print device use during non-peak time periods. The method 300 may be implemented on a promotion system that includes at least one printing device, e.g. system 100 of FIG. 1. The method 300 may be implemented on a stand alone server, e.g. server 103 of FIG. 1, or it may be implemented on a print server, e.g. networking device 110 of FIG. 1. Alternatively, the method 300 may be implemented on the print device itself. The scenarios described herein are not limited in this regard.

The method 300 begins when the promotion system receives data corresponding to measurements of usage of a print device over a set of baseline time periods 302. The measurements of usage may be a simple count of print jobs received and processed by the print device. Alternatively, the usage measurement may be an estimation or measurement of the amount of consumables utilized during the time period (e.g., a percentage fill of an ink cartridge times the number of pages printed); total usage time; a number of users; a page count of pages printed, scanned, or otherwise processed; or other measurements.

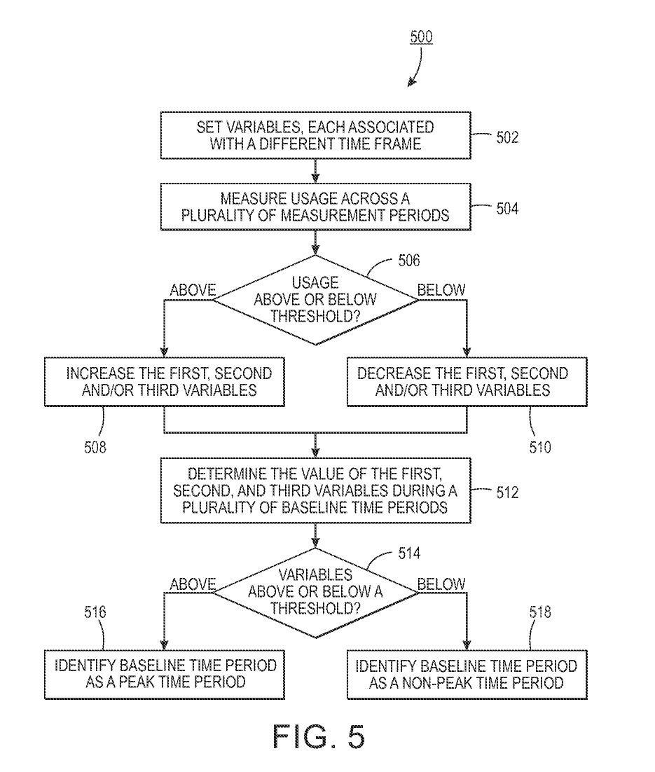

Also using the measurements of usage, peak and non-peak time periods are identified 304. Non-peak time periods are those periods that include a measured usage below a lower threshold. Peak time periods are those periods that include measured usage above an upper threshold. As previously described, the thresholds may be specific numbers, or they may be dynamically determined based on the measurements of usage. As described in greater detail below in reference to FIG. 5, the system uses measurements of usage to determine whether a particular time period is a peak or non-peak time period. A non-peak time period is a time period where the usage of the print device is low. A peak time period is a time period where the usage of the print device is high.

The objective of a promotion system is to increase usage during non-peak times. This is accomplished by selecting a promotion for the print device that includes a time window and/or a page count and a promotional usage or price discount 306. The time window is a time period during which the promotion is active. Alternatively, a promotion may be provided as a page count that the user may draw down at a promotional rate. The promotion system selects a time window according to an algorithm. This selection algorithm may be a simple time based algorithm that selects the time periods that record the least use. For example, the promotion system may recognize and forecast usage patterns and time period opportunities based on a long term and/or short term use history. In some scenarios, this analysis may yield specific known low usage times such as at night, at lunch, on the weekend, or on holidays. In other scenarios, the identified low usage time periods can be selected at random or can be customer selected dates and times. In further scenarios, the promotion system may select the time window based on a promotion or other advertising campaign.

The selection algorithm may include more complex selection techniques as well. In some scenarios, the selection of the promotion may be based on business intelligence gathered from usage profiles. For example, a print device may track the quantity and type of print jobs by time frame as part of a usage profile data system. Such a usage profile data system may be configured to identify time periods or usage patterns where reduced cost incentives can be offered to increase print device revenue. In one scenario, promotions could be offered on the basis of low usage or low total numbers of connected users. For example, if a printer detects low usage, the algorithm may offer an aggressive promotion timed during higher usage times. Alternatively, aggressive promotion may be timed during lower usage times to encourage use during non-peak times. When users connect to the print device and begin to take advantage of the promotional rates, the promotion system may start to slowly decrease the amount and/or change the timing of the promotions. Other scenarios may take advantage of other currently existing systems, such as systems that monitor use to control printer time outs (i.e. powering down during low or no usage to conserve power and powering up during high usage times to speed up printing). This scenario is described more fully below in reference to FIG. 5.

After a promotion has been selected, a message or other notification is generated to alert customers about the selected promotion 308. Notification of promotions and applicable time periods may be delivered to the customer through a number of different methods, any or all of which might be utilized without limitation. Specific incentives or earned promotions offering low/no cost print periods can vary over time and/or by product. The specific promotions can also be specific to the customer or user site activity. Examples of types of promotions may include a reduced price per print job or per page processed by the device to which the promotion applies, a reduced price for an order of consumables if the data shows that customer's usage during a non-peak period satisfies an eligibility criterion (such as increased by a threshold eligibility amount), and/or other promotions.

Notification may be accomplished through any appropriate medium, such as by using the Internet and connecting directly to the print device, or through a pre-designed software interface which allows the printer to accept promotion codes. In some scenarios, notification of promotions may be accomplished through the printer driver or other device, computer, or web based software. For example, a promotions schedule and/or reminders could be displayed real time and/or show up at the time the user makes a print. Alternatively, the customer may log into the device to see the promotion and/or the current and potentially future, promotion schedules. In other scenarios, the notification could be communicated direction to the customers through a unicast/broadcast medium. For example, the notification may be communicated through an e-mail for user “subscribers”, either over the Web through custom software or sent by the print device. Alternatively, the notification may be communicated through a mobile phone text message, using the Web or the printer itself. The promotions can be offered to customers via a text message to their phone, tablet computer, or any other device, again based on those that wish to subscribe to this service. In some scenarios the notification may be communicated through a personal phone call. Promotions may be offered to select customers and/or user subscribers where a personal relationship is important.

Still other scenarios communicate the through the front panel of the print device or other product notification device. For example, the front panel may display a message that communicates the next “free/reduced” cost schedule. The print device could also supply a physical, visual, or audible signal or alert. For example, an LED on the printer may blink when the printing is in promotion mode or the front panel may display a specific message or graphic to communicate to the customers that a promotion is being offered. An audible signal, such as a melody, beep, or even voice annunciation could be used. In other scenarios, the promotion can also be sent from the print device or promotion system to the individual users as a flashing icon or dialog box on a screen of properly set-up and connected personal computers, mobile phones, and the like.

After the message is generated and sent to the customer, the promotion system receives an indication that the customer accepts the selected promotion 310. This indication may be a return message, such as to an email or text message. Alternatively, the indication can be in the form of a promotional code, provided in the generated message, that the customer must input into the promotion system. In one scenario, the promotion code is input into a printer driver dialog, i.e. when the customer sends a print job to a print device. For example, a printer driver dialog or screen may present a button or input box for the promotion. This system may be similar to that provided in commonly owned U.S. Pat. No. 7,474,433, titled “Print Driver Based Marketing System and Method,” issued Jan. 6, 2006, the disclosure of which is fully incorporated by reference. Alternatively, acceptance may be indicated through a message or other indication from a user at a personal computer, smart phone, or tablet computer. Acceptance can also be indicated via direct input into the control panel of the print device itself.

After the promotion is selected, notification is sent, and the customer accepts the promotion, the promotion system receives data corresponding to measurements of usage of the print device over a number of additional time periods, including the time window of the promotion 312. The measurement of usage during the additional time periods, after the promotion has been put into effect, generate important information concerning the efficacy of the promotions offered. The promotion system can compile the usage data during the baseline time periods into a usage history 314. This usage history, with may take the form a usage profile described above, can be used to forecast future time periods where usage will be below a lower threshold 316. These forecast non-peak time periods can be used to select a promotion and/or the time window. This information is fed back into the promotion system to evaluate the promotions and to perform billing procedures including the promotions.

It may be beneficial for promotion system administrators to require that peak usage does not go down so that it is no longer a peak time period. In other words, the promotion may only be offered if the usage during peak periods remains above the upper threshold. The promotion system then checks the usage during the additional time periods to ensure that usage during peak periods does not go below the upper threshold 318. In some scenarios the promotion system may determine whether an average usage remains above the threshold. Alternatively, the promotion system may determine whether a percentage of the peak periods remain above the threshold. For example, the promotional system may check that usage during at least some percentage of the peak periods does not dip below the threshold. One of skill in the art will recognize that any suitable metric may be used to fit customer needs. If the usage remains above the threshold, the promotion is offered to the customer. If the usage drops below the threshold, the promotion may be withdrawn, not offered, or not applied 332.

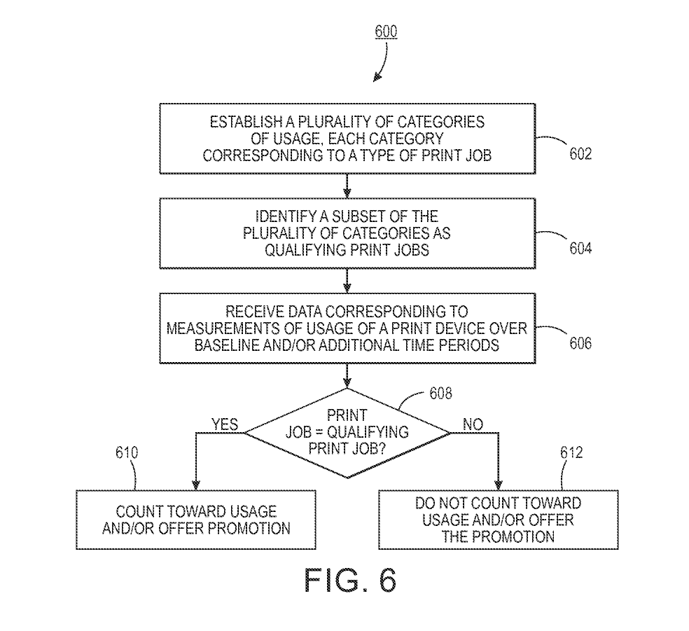

The billing procedure used may be based on the revenue base for the print device. Therefore, the promotion system determines the revenue base used for that customer 320. As mentioned above, there may be at least two general revenue bases for printing. One is charging a customer on a per-unit (e.g. per page) basis. In this scenario, a per-unit price is applied during each non-promotional time period 322. During non-promotional periods, the printing cost is set according to a standard rate agreed upon by the customer. For example, a standard rate of $0.01 per page may be applied. Alternatively, any of multiple rates may be applied according to the type of print job that is sent to the print device. For example, the rate of $0.01 per page may apply to black and white printing while a different rate of $0.025 per page may apply to color printing. During promotion time periods, a promotional per unit price is applied to print jobs occurring with the time window of the promotion 324. For example, a promotional rate of $0.02 per page is applied to usage during the promotional time window. Alternatively, usage could be entirely free during the promotional time window. As explained in greater detail below in reference to FIG. 6, certain print jobs may qualify for the discount while others do not. After the appropriate rates are applied to all usage in a billing cycle, a statement is generated and submitted to the customer for payment 326.

A second basis for generating revenue from printing is replenishment and replacement of consumables. Since this revenue model depends on high usage and the consequent high turnover of consumables, such as ink and toner cartridges, a promotion that increases print device usage can increase revenue even though the consumables may be offered with a promotional discount. Therefore, one scenario makes a determination of whether the usage is above a target usage level 328. If the usage is above the target usage level, a promotion is applied 330. For example, if a target usage level is met, a percentage discount is applied to the customers account to be applied to the next consumables order. The customer may take advantage of a number of promotional periods between consumables orders and with a sufficient amount of usage, as substantial discount on consumables may be applied. If the usage is not above the target usage level, the promotion is not applied 332.

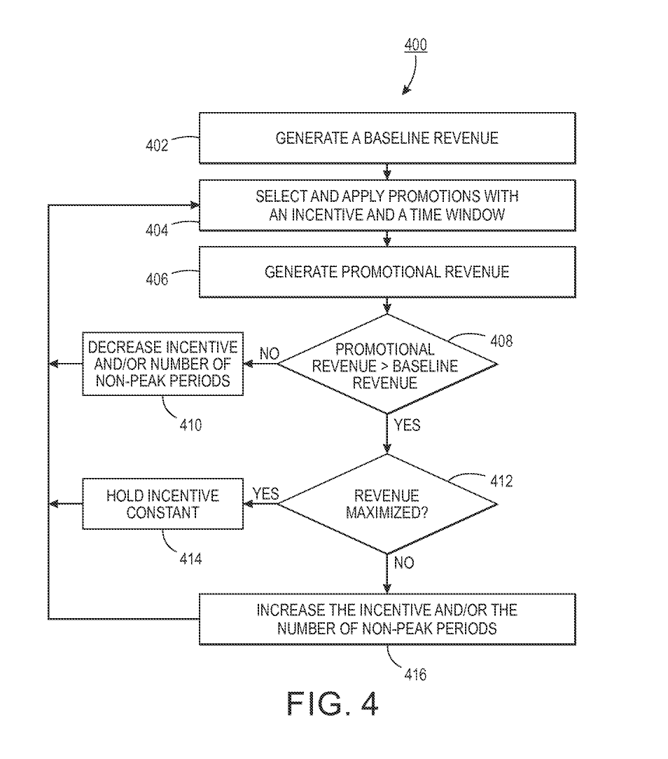

Referring to FIG. 4, a flow chart is provided that describes a method 400, a scenario designed to optimize or maximize revenue using the measurements of usage. Using the measurements of usage during the baseline time periods, a baseline revenue is generated 402. The baseline revenue tracks the usage, i.e. the type and quantity of print jobs, of a print device over a particular time period or periods. Revenue is generated based on one of two general revenue bases: consumables and per-use charging. Consumable sales basis for revenue depends on customer use and exhaustion of consumable items, such as ink or toner cartridges. Therefore, the customer does not incur a cost per print job, but must pay to replenish or replace consumables used during the printing process. Alternatively, a per-use basis for revenue depends on a per-unit cost to the customer. In this scenario, the customer does not pay to replace consumables used during printing, but is charged a per-unit cased based on print volume. In a typical scenario, the customer is charged a set amount per page.

Regardless of the revenue base, the promotion system selects and applies promotions as described above in reference to FIG. 3. After the promotion is applied to the customer's account, the promotion system generates a promotional revenue from the print device based on the measurements of usage during the additional time periods 406. The generated promotional revenue takes into account the promotional discount applied to the customer's usage. The promotion system then compares the promotional revenue to the baseline revenue to determine whether the promotional revenue increased the baseline revenue 408. If the revenue is decreased, i.e. the promotional revenue is not greater than the baseline revenue, the incentive is decreased 410. For example, the promotional rate (either per-page or the percentage discount) may be decreased. Alternatively, the promotional time window may be decreased. Since the time window is determined based on the presence and quantity of non-peak periods, decreasing the number of non-peak periods by adjusting the lower threshold can also decrease the incentive. After the incentive is decreased, it is fed back into the promotion system and a new promotion based on the adjusted incentive is selected and applied.

If the promotional revenue is greater than the baseline revenue, the promotion is effective to raise overall revenue. Further upward adjustments to the incentive provided by the promotion may be effective to maximize or optimize revenue generated by the print device. It is important to note that too many promotions will serve to decrease revenue while too few promotions will not effectively incentivize more general printing. Therefore, the promotion system will check the current incentive to see if revenue has been maximized 412. If a maximum incentive (i.e. maximum revenue) is reached, the promotion system holds the incentive constant 414. If the revenue is not maximized, the incentive is increased 416. After the incentive is increased, it is fed back into the promotion system and a new promotion based on the adjusted incentive is selected and applied.

Referring now to FIG. 5, a flowchart describing a method 500 is provided that determines whether a time period is a peak or a non-peak time period. Method 500 uses time periods of varying length. For example, the system may identify any number of variables, each of which corresponds to a customer usage pattern during a time period. The time period for each variable will be unique to the variable. For example, the three variables can be denoted as IR1, IR2, and IR3. IR1 may correspond to minute by minute usage, IR2 may correspond to day by day usage, and IR3 may correspond to weekly or monthly usage patterns. The system uses an algorithm to add and/or subtract a value based on usage to control the print device's time-outs. When the usage is lowest, the IR values are very low, and this may cause the printers to enter low power and sleep modes more quickly. When the IR values are high, the printers may take much longer to enter low power and sleep modes. Method 500 can use these values to determine when to offer promotions, since the values are directly related to customer usage. Any suitable algorithm may be used, and the variables and functions can be selected based on other factors including copy volume, total coverage, time and/or combinations of these factors.

Method 500 begins with identifying a number of variables 502. As discussed above, each variable corresponds to a usage measurement during different time frames or intervals. The time intervals for each variable may be unique to that variable.

Usage of the print device is measured for a plurality of measurement periods 504. These measurement periods may be similar to the baseline and/or additional time periods discussed above, or may be smaller time periods within the baseline and/or additional time periods. For each measurement period, the promotion system determines if print device usage was above or below a threshold 506. The thresholds may be dynamically adjusted based on usage measurements and/or promotion effectiveness. For example, based on the usage measurements, the threshold for one or more of the time intervals may be increased or decreased. The amount of the change may vary by variable. For example, since the first variable responds to hourly changes in usage, its threshold may be changed more than other variables which measure over longer time frames. In any case, if the usage is above the threshold, the threshold may be increased 508. If the usage is below the threshold, the threshold may be decreased 510. Alternatively, if usage increases during a time interval after a promotion is introduced, the system may reduce the upper threshold or increase the lower threshold to encourage more promotional activity.

After the usage has been measured across all the measurement periods (i.e. across the baseline and/or additional time periods described above), the promotion system determines the values of the variables during the baseline and/or additional time periods 512. As described above, the measurement periods may or may not be similar to the baseline time periods. Additionally the measurement periods may be different for each variable. The baseline time periods, however are set length and are the basis for determining peak and non-peak time periods. The promotional system then determines whether the variables are above or below a threshold for each of the baseline and/or additional time periods 514. This may be done through a weighted algorithm or other suitable method. If the variables are above a threshold, the time period is a peak time period 516. If they are not above a threshold it is a non-peak time period 518.

Referring now to FIG. 6, a flow chart is provided that describes a method 600. The promotional system establishes categories of usage 602. In a scenario, each category corresponds to a type of print job. As described above, a print job is any job that is to be printed, scanned or otherwise processed by a print device. Some print jobs may impact revenue more than others. For example, printing a document may impact revenue in a way that is different than scanning a document, because scanning requires less use of consumables. For this reason, it may be beneficial to identify a subset of qualifying print job categories 604. Data is received corresponding to usage of the print device over baseline and/or additional time periods 606. When analyzing the data, the promotion system may categorize the print jobs sent to the print device and determine whether they were qualifying print jobs because they are in a category that satisfies one or more qualification criteria 608. In this scenario, the promotion system only counts qualifying jobs toward the selected promotion. Therefore, if the print job is a qualifying job, the job is counted toward the promotion 610. If the print job is not a qualifying job, it is not counted toward the promotion 612. Alternatively, the promotion system may use the qualification criteria to only count qualifying print jobs in the measurements of usage.

FIG. 7 depicts a block diagram of internal hardware that may be used to contain or implement the process discussed above. A bus 700 serves as the main information highway interconnecting the other illustrated components of the hardware. CPU 705 is a processor, the central processing unit of the system that performs calculations and logic operations required to execute a program. CPU 705, alone or in conjunction with one or more of the other elements disclosed in FIG. 7, is a processing device, computing device or processor as such terms are used within this disclosure. Read only memory (ROM) 710 and random access memory (RAM) 715 constitute exemplary memory devices.

A controller 720 provides an interface between with one or more optional tangible, computer-readable memory devices 725 and the system bus 700. These memory devices 725 may include, for example, an external or internal DVD or CD ROM drive, a hard drive, flash memory, a USB drive or the like. As indicated previously, these various drives and controllers are optional devices. Additionally, the memory devices 725 may be configured to include individual files for storing any software modules or instructions, auxiliary data, common files for storing groups of results or auxiliary, or one or more databases for storing the result information, auxiliary data, and related information as discussed above.

Program instructions, software or interactive modules for performing any of the methods and systems as discussed above may be stored in the ROM 710 and/or the RAM 715. Optionally, the program instructions may be stored on a tangible computer readable medium such as a compact disk, a digital disk, flash memory, a memory card, a USB drive, an optical disc storage medium, such as a Blu-ray™ disc, and/or other recording medium.

An optional display interface 740 may permit information from the bus 700 to be displayed on the display 745 in audio, visual, graphic or alphanumeric format. The information may include information related to a current job ticket and associated tasks. Communication with external devices may occur using various communication ports 750. A communication port 750 may be attached to a communications network, such as the Internet or an local area network.

The hardware may also include an interface 755 which allows for receipt of data from input devices such as a keyboard 760 or other input device 765 such as a mouse, a joystick, a touch screen, a remote control, a pointing device, a video input device and/or an audio input device.

Some or all of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the claims.

1. A method of promoting usage of a print device during non-peak time periods, comprising, by a processor:
receiving data corresponding to measurements of usage of a print device over a plurality of baseline time periods;
identifying at least one non-peak time period, each non-peak time period being one of the baseline time periods during which the measurement of usage is below a lower threshold level;
selecting a promotion for the print device, wherein the promotion represents a reduced price for a consumable item that is used by the print device, the promotion comprising a time window and one or more target usage criteria;
generating a message with the selected promotion;
receiving data corresponding to measurements of usage of the print device over a plurality of additional time periods, wherein at least one of the additional time periods corresponds to the time window of the promotion;
determining whether the usage during the time window satisfied the one or more target usage criteria; and
offering the consumer the consumable item at the reduced price.

2. The method according to claim 1, further comprising:
identifying at least one peak time period, each peak time period comprising at least one of the baseline time periods during which the measurement of usage is above an upper threshold level;
determining that at least one of the additional time periods for which data was received corresponds to at least one of the peak time periods;
determining whether the usage during any additional time period that corresponds to a peak time period dropped below the upper threshold level; and
performing the offering only if the usage during each additional time period that corresponds to a peak time period did not drop below the upper threshold level.

3. The method according to claim 1, wherein the identifying at least one non-peak time period further comprises:
identifying a first variable, a second variable, and a third variable, wherein each variable corresponds to a usage measurement during a plurality of time intervals, and the time intervals for each variable are unique to the variable;
upon identifying a condition that the measurement of usage during the measurement period for one of the variables is below the lower threshold level, reducing the lower threshold; and
wherein identifying the at least one non-peak time period comprises identifying the one or more baseline time periods that have values of the first, second, and third variables below a lower threshold value.

4. The method according to claim 2, wherein the identifying at least one peak time period further comprises:
identifying a first variable, a second variable, and a third variable, wherein each variable corresponds to a usage measurement during a plurality of time intervals, and the time intervals for each variable are unique to the variable; and
upon identifying a condition that the measurements of usage during the measurement period for one of the variables is above the upper threshold level, increasing the lower threshold level.

5. The method according to claim 1, further comprising:
compiling the data corresponding to measurements of usage during the plurality of baseline time periods into a usage history;
forecasting at least one future time period where usage is expected to be below the lower threshold level based on the usage history; and
setting the time window to correspond to the at least one future time period.

6. The method according to claim 2, further comprising:
before selecting the promotion, generating a baseline revenue for the print device based on the data corresponding to measurements of usage during the plurality of baseline time periods; and
performing the offering only if the baseline revenue is below a lower threshold revenue level.

7. The method according to claim 6, further comprising:
after performing the offering, generating a promotional revenue for the print device based on the measurements of usage during the time window; and
on a condition that the promotional revenue is greater than the baseline revenue, increasing the number of non-peak time periods by adjusting the lower threshold level or the upper threshold level.

8. The method according to claim 7, further comprising discontinuing the adjusting on a condition that the number of identified non-peak time periods reaches a predetermined maximum.

9. The method according to claim 1, further comprising:
establishing a plurality of categories of usage, each category corresponding to a type of print job;
establishing a subset of the plurality of categories as qualifying print jobs; and
only counting qualifying print jobs in the measurements of usage during the plurality of additional time periods.

10. The method according to claim 1, further comprising receiving an acceptance to the offering via consumer input of a response to the promotion at the print device.

11. The method according to claim 1, further comprising outputting the message with the selected promotion at the print device.

12. A method of promoting usage of a print device during non-peak time period, comprising, by a processor:
receiving data corresponding to measurements of usage of a print device over a plurality of baseline time periods;
identifying at least one non-peak time period, each non-peak time period being one of the time periods during which the measurement of usage is below a lower threshold level;
selecting a promotion for the print device, wherein the promotion represents a reduced price for a function of the print device, the promotion comprising a time window and one or more target usage criteria;
generating a message with the selected promotion;
receiving data corresponding to measurements of usage of the print device over a plurality of additional time periods, wherein at least one of the additional time periods corresponds to the time window of the promotion, and at least one of the additional time periods corresponds to a non-promotional time period;
determining a payment amount due for usage during the plurality of additional time periods by:
applying a standard price to the usage that occurred during each non-promotional time period, and
applying the promotional price to the usage that occurred during the time window of the promotion; and
generating a statement of the payment amount due.

13. The method of claim 12, further comprising:
identifying at least one peak time period, each peak time period comprising at least one of the time periods during which the measurement of usage is above an upper threshold level;
determining whether the measurement of usage during any peak time period was below a baseline threshold level, wherein the baseline threshold level is less than the upper threshold level; and
selecting the promotion, generating the message, and applying the promotional price only if the usage during each peak time period was at least equal to the baseline threshold level.

14. The method according to claim 13, wherein the identifying at least one non-peak time period further comprises:
identifying a first variable, a second variable, and a third variable, wherein each variable corresponds to a usage measurement during a plurality of time intervals, and the time intervals for each variable are unique to the variable; and
upon identifying a condition that the measurements of usage are below the lower threshold level during a respective time period for the first, second, and third variables, reducing the lower threshold level.

15. The method according to claim 14, wherein the step of identifying at least one peak time period further comprises:
identifying a first variable, a second variable, and a third variable, wherein each variable variable corresponds to a usage measurement during a plurality of time intervals, and the time intervals for each variable are unique to the variable;
upon identifying a condition that the measurements of usage are above the upper threshold level during a respective time period for the first, second, and third variables, increasing the upper threshold level; and
wherein identifying the at least one peak time period comprises identifying the one or more baseline time periods that have values of the first, second, and third variables above an upper threshold value.

16. The method according to claim 13, further comprising:
compiling data corresponding to measurements of usage during the plurality of baseline time periods; and
forecasting at least one future time period where usage is expected to be below the lower threshold level based on the usage history; and
setting the time window to correspond to the at least one future time period.

17. The method according to claim 13, further comprising:
before selecting the promotion, generate a baseline revenue for the print device based on the data corresponding to measurements of usage during the plurality of baseline time periods; and
applying the promotional per-unit price only if the baseline revenue is below a lower threshold revenue level.

18. The method according to claim 17, further comprising:
after applying the promotional per-unit price, generate a promotional revenue for the print device based on the measurements of usage during the time window; and
on a condition that the promotional revenue is greater than the baseline revenue, increasing the number of non-peak time periods by adjusting the lower threshold level or the upper threshold level.

19. The method according to claim 18, further comprising discontinuing the adjusting on a condition that the number of identified non-peak time periods reaches a predetermined maximum.

20. The method according to claim 13, further comprising:
establishing a plurality of categories of usage, each category corresponding to a type of print job;
establishing a subset of the plurality of categories as qualifying print jobs; and
only counting qualifying print jobs in the measurements of usage during the plurality of additional time periods.

21. The method according to claim 12, further comprising receiving an acceptance to the offering via consumer input of a response to the promotion at the print device.

22. A print device promotion system comprising:
at least one print device;
a processor in communication with the at least one print device;
a computer readable storage medium configured to store program instructions which, when executed, cause the processor to:
receive data corresponding to measurements of usage of a print device over a plurality of baseline time periods;
identify at least one non-peak time period, each non-peak time period being one of the baseline time periods during which the measurement of usage is below a lower threshold level;
select a promotion for the print device, wherein the promotion represents a reduced price for a consumable item that is used by the print device, the promotion comprising a time window and one or more target usage criteria;
generate a message with the selected promotion;
receive data corresponding to measurements of usage of the print device over a plurality of additional time periods, wherein at least one of the additional time periods corresponds to the time window of the promotion;
determine whether the usage during the time window satisfied the one or more target usage criteria; and
offer the consumer the consumable item at the reduced price.

23. The system of claim 22, wherein the program instructions, when executed, further instruct the processor to:
identify at least one peak time period, each peak time period comprising at least one of the baseline time periods during which the measurement of usage is above an upper threshold level;
determine that at least one of the additional time periods for which data was received corresponds to at least one of the peak time periods;
determine whether the usage during any additional time period that corresponds to a peak time period dropped below the upper threshold level; and
perform the offering only if the usage during each additional time period that corresponds to a peak time period did not drop below the upper threshold level.
before selecting the promotion, generate a baseline revenue for the print device based on the data corresponding to measurements of usage during the plurality of baseline time periods; and
perform the offering only if the baseline revenue is below a lower threshold revenue level.

24. The system of claim 23, wherein the program instructions, when executed, further instruct the processor to:
before selecting the promotion, generate a baseline revenue for the print device based on the data corresponding to measurements of usage during the plurality of baseline time periods;
perform the offering only if the baseline revenue is below a lower threshold revenue level;
after performing the offering, generate a promotional revenue for the print device based on the measurements of usage during the time window;
on a condition that the promotional revenue is greater than the baseline revenue, increase the number of non-peak time periods by adjusting the lower threshold level or the upper threshold level; and
discontinue the adjusting on a condition that the number of identified non-peak time periods reaches a maximum.
